(19) United States
(12) Patent Application Publication
(10) Pub. No.: US 2006/0291602 A1
(43) Pub. Date: Dec. 28, 2006

(54) Communications link clock recovery

(75) Inventor: Adee Ran, Maayan Baruch (IL)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 11/165,147

(22) Filed: Jun. 23, 2005

(51) Int. Cl. H04L 7/00

(52) U.S. Cl. 375/355; 375/371

(57) ABSTRACT

Apparatus and systems, as well as methods and articles, may operate to receive a data signal from a transmitter at a selected channel included in a plurality of receiver channels, derive clock frequency deviation information from the data signal, receive an operational mode indication, and communicate the clock frequency deviation information to a remainder of the plurality of receiver channels responsive to receiving the operational mode indication, which may include a slave mode indication, a master mode indication, a full-duplex mode indication, or a half-duplex mode indication.

### TECHNICAL FIELD

Various embodiments described herein relate to data communications generally, including apparatus, systems, and methods used to recover communications link clock information.

### BACKGROUND INFORMATION

Reliable full-duplex 1000Base-T network operation can present interesting design challenges. On each of four channels, the transmitted signal may create an echo in the receiver that is added as noise to the desired far-end signal. To increase the signal-to-noise ratio (SNR), measures may be taken to suppress the echo. For example, some degree of suppression may be achieved by using adaptive filtering methods to reconstruct echo channel transfer functions from received signals.

In some cases, echo attenuation and synchronization tasks for a given channel may be coupled. Thus, an initial coarse estimate of the echo transfer function may be used to reduce the echo and permit recovery of the clock signal. When clock signal recovery succeeds, the echo may be further reduced using adaptive filtering, so that eventually, a synchronized, low-noise channel can be created. However, as the cable length between parties increases, the far-end signal may suffer greater attenuation than the echo signal. As a result, the SNR may decrease, and above certain lengths, the SNR may become too low to recover the clock signal and establish a reliable link.

### BRIEF DESCRIPTION OF THE DRAWINGS

FIGS. 1A and 1B are block diagrams of apparatus and systems according to various embodiments of the invention.

FIG. 2 is a flow diagram illustrating several methods according to various embodiments of the invention.

FIG. 3 is a block diagram of an article according to various embodiments.

### DETAILED DESCRIPTION

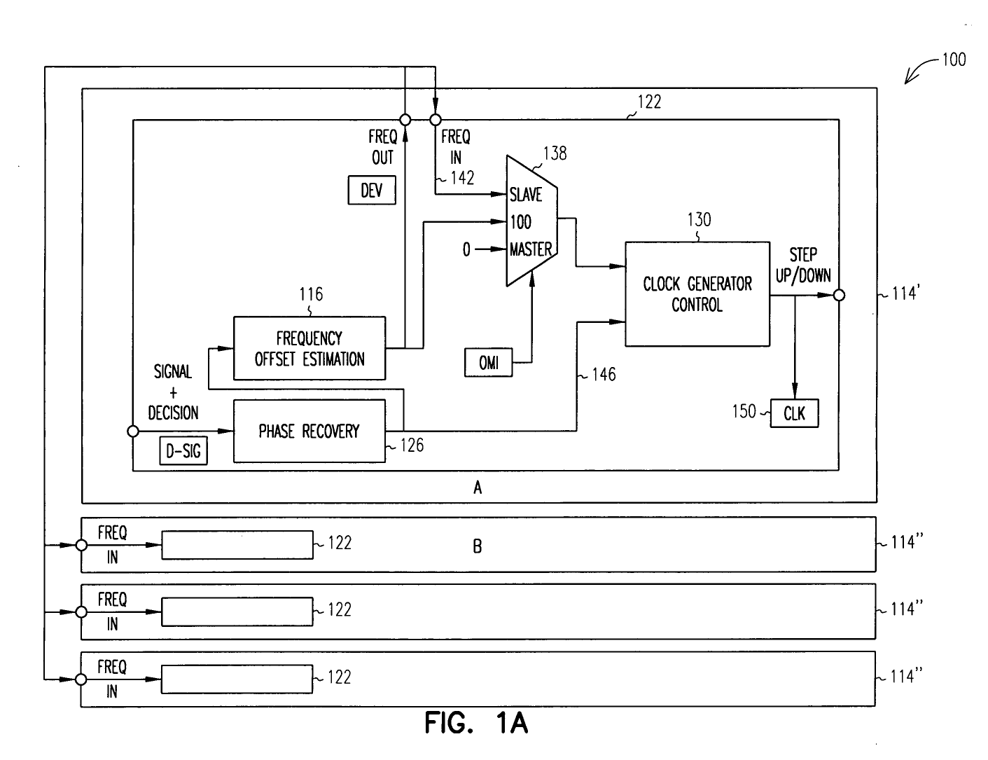

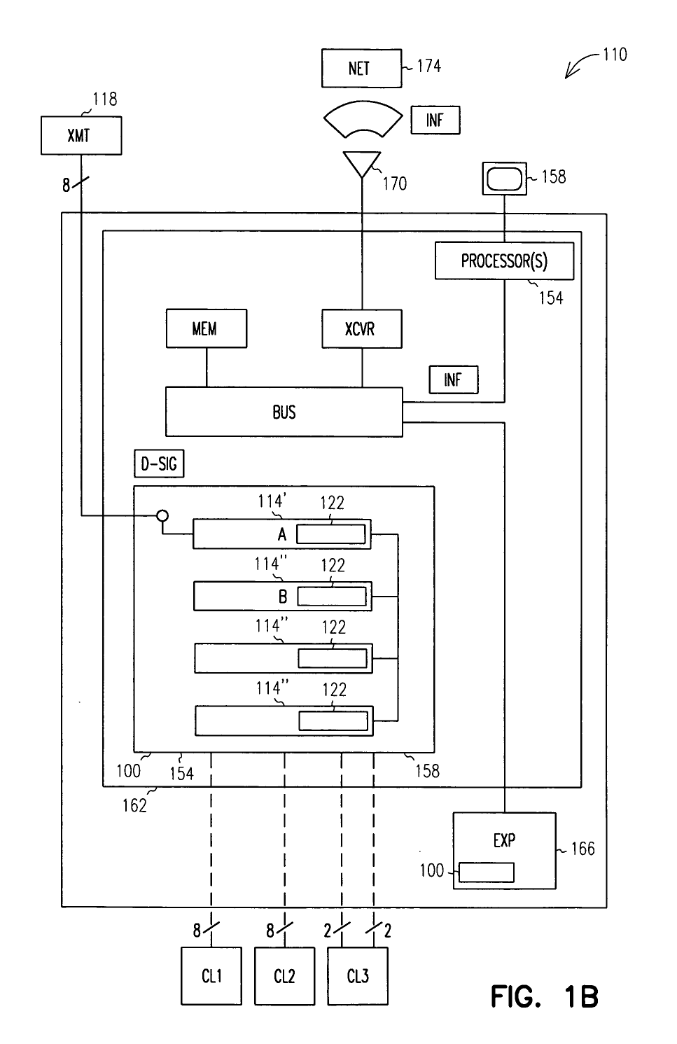

FIGS. 1A and 1B are block diagrams of apparatus 100 and systems 110 according to various embodiments of the invention. The apparatus 100 may include a plurality of receiver channels 114, one of which is selected to receive a data signal D-SIG from a transmitter 118, which may comprise a server. The apparatus 100 may also include a time recovery module 122 to communicate clock frequency deviation information DEV derived from the data signal D-SIG from the selected channel 114′ to a remainder of the plurality of receiver channels 114″. Communication of the clock frequency deviation information DEV may be responsive to an operational mode indication OMI indicating one of several modes, such as a master mode, a slave mode (e.g., both of which are full-duplex modes in a 1000Base-T network), or a half-duplex mode, such as a master mode or slave mode in a 100Base-TX network.

It should be noted that, while the use of clock frequency deviation information DEV is discussed in conjunction with 1000Base-T and 100Base-TX operations herein, the various embodiments described are not to be so limited. Many full-duplex synchronous communications apparatus 100 and systems 110 with master and slave operation modes, as well as some that offer half-duplex operations, can take advantages of the mechanisms disclosed.

According to 1000Base-T network operational specifications, a communication link may be established between two parties—a master and a slave. Each may have a local clock that operates at a nominal frequency of 125 MHz±100 PPM (e.g., about 0.01% frequency deviation is allowed). The master uses its local clock to transmit pulse-amplitude modulated (PAM) symbols over four twisted-pair channels (e.g., a Category 5 (CAT-5) network cable that includes four twisted pairs of wire terminated by RJ45 connectors). The slave may be used to recover the master clock on one of the channels and then to use the recovered clock to transmit symbols in a similar fashion over the same four twisted-pair channels. For more information regarding 1000Base-T network communications, as well as 100Base-TX network communications, please refer to the Institute of Electrical and Electronics Engineers (IEEE) Computer Society LAN MAN Standards Committee, Part 3: Carrier Sense Multiple Access with Collision Detection (CSMA/CD) Access Method and Physical Layer Specifications, IEEE Std. 802.3 2000, incorporating the content of IEEE Std 802.3ab 1999, and related amendments.

For symmetry and simplicity reasons, some embodiments may include duplicated channel 114 circuitry. Also, the apparatus 100 and systems 110 may be implemented so as to be capable of operating both as master and as a slave, since the role assignment can be negotiated between the parties at the beginning of link creation in some networks.

In order for one party to decode the symbols transmitted by another, it should lock the clock frequency and phase for each of the four receiver channels 114 correctly, so that the received signal D-SIG is sampled at the right points in time. This process is known as synchronization or time recovery. Time recovery should be performed separately on each channel, since the correct phase is likely to vary from channel to channel. While various methods may be used to recover time or clock information from the received signals, most of them depend on the channel SNR for effectiveness. When the SNR is high, the recovered clock signal is usually more accurate than when the SNR is reduced, since recovered clock jitter may be increased until time recovery is impossible.

In many embodiments, a high-speed, full-duplex link may be established over extended cable lengths by using additional information to improve time recovery results. In this case, the additional information may comprise clock frequency deviation information DEV, which may include an estimate of the frequency deviation between the received signal's clock and the transmitted signal's clock.

For full-duplex operation (e.g., 1000Base-T), the estimate may be different for master and slave modes. For example, in the master mode, assume the local transmit clock has frequency f₀. The slave is expected to recover this frequency at its receiver and use it in its own transmit clock (e.g., the remote transmit clock) to transmit symbols. Therefore the master's local receive clock must eventually operate at the same frequency f₀ as the local transmit clock, and the frequency deviation estimate is substantially zero. This estimate may be correct only after the receiver successfully recovers the clock; any other estimate before that point in time will likely be incorrect, since a link cannot be achieved unless the slave is locked.

In the slave mode, the local transmit clock (which may be common to all receive channels 114) may be created from the local receive clock of a selected channel 114′. For the selected channel 114′, the transmit clock and the receive clock are phase-locked by definition. Thus, the echo transfer function is constant in time and good echo cancellation can be achieved. Therefore the selected channel 114′ may be endowed with a high SNR before time recovery starts, perhaps enabling clock recovery to succeed over longer cable lengths than would be possible using the remaining channels 114″. The frequency deviation estimate of the selected channel 114′ is thus fed as clock frequency deviation information DEV to the remaining channels 114″. While the estimate may be correct only after the selected channel 114′ successfully recovers the clock information, it should present the best conditions for time recovery and synchronize faster than the other channels, since it may be the only channel with a time-invariant echo. In some embodiments, then, disconnecting one channel (e.g., the selected channel 114′) from the signal D-SIG can disable the time recovery function for the remaining channels 114″.

Clock recovery may also be performed for a communications link operating in a half-duplex mode, such as the 100Base-TX mode, where no master/slave roles exist, and only one channel receiver per physical layer (e.g., the PHY layer, or the lowest layer in the open system interconnection (OSI) network model) is active at a time. In this mode, the receiver can make use of its own frequency estimate. Transmission and reception occur on distinct channels (e.g., half-duplex operation); full-duplex echoes are non-existent, and clock recovery operations can be simplified.

Thus, some embodiments of the apparatus 100 and systems 110 may use clock frequency deviation information DEV as part of the time recovery module 122 for several operational modes, including a master mode, a slave mode, and a half-duplex or 100Base-TX mode. If the operational mode indicator OMI indicates slave mode operation, one of the four channels (e.g., channel A) may be used to supply clock frequency deviation information DEV to the remaining three channels 114″. In some embodiments, a common channel design may be implemented, such that the clock frequency deviation information DEV is fed into each channel. For example, in the full-duplex slave mode, the clock frequency deviation information DEV may be fed back into the selected channel 114′, and out to the remaining channels 114″. Thus, the time recovery module 122 may be included in the selected channel 114′, and duplicates of the time recovery module 122 may be included in one or more of the remainder of the plurality of receiver channels 114″.

In this manner, various embodiments may operate to provide a receive clock that has the correct frequency with an unknown phase. Both clock recovery and echo cancellation tasks may be augmented. For example, when a good estimate of the frequency deviation is known, the local receive clock frequency can be adjusted accordingly (in slave mode) or kept fixed (in master mode). Since the receive clock and transmit clock should have about the same frequency f₀, the clock recovery task can be reduced to finding the best phase of the receive clock with respect to the transmit clock for each channel. This task is simpler, and can be accomplished more accurately than the original task of finding both the frequency deviation and the correct phase.

In addition, time-variation in the echo channel can be greatly reduced, since phase adaptation can be slowed down so as to enable some amount of echo channel adaptation even before phase information has been accurately recovered. Thus, the echo cancellation function may be more accurate, improving the link SNR, which in turn improves clock recovery.

As noted previously, an apparatus 100 (e.g., a receiver) may operate as either a slave or as a master. If the receiver operates as a slave then its channels 114 should all adjust their frequency using the frequency recovered from the received signal (and transmitted by the master). If the receiver operates as a master, then its channels 114 should all refrain from adjusting their frequency according to any received signals.

Some embodiments of the apparatus 100 may be able to select between operating in three different modes using the same time recovery module 122. These modes include: selected slave receiver channel (e.g., channel 114′), remainder of the plurality of slave receiver channels (e.g., channels 114″), and master receiver channels (e.g., channels 114). Thus, rather than using a dedicated module to communicate the frequency information between the channels, some embodiments may duplicate the time recovery module 122 in each channel A-D, and use only the interconnection of existing signals between the channels, and the operational mode indication, to communicate among themselves. In any case, the phase recovery and frequency recovery operations may be accomplished in a manner similar to or identical to that employed by a variety of circuitry known to those of skill in the art, including circuitry similar to or identical to that included in the Micrel SY87702L clock recovery and data retiming integrated circuit, available from Micrel, Inc. of San Jose, Calif.

In some embodiments, the apparatus 100, such as an Ethernet controller, or a PHY transceiver, may include a plurality of receiver channels 114, including a selected channel 114′ to receive a data signal D-SIG from a transmitter 118. The apparatus 100 may also include a time recovery module 122 to communicate clock frequency deviation information DEV derived from the data signal D-SIG to a remainder of the plurality of receiver channels 114″, perhaps responsive to an operational mode indication OMI, indicating a slave mode, a master mode, a full-duplex mode (e.g., a 1000Base-T mode, as either a master or slave), or a half-duplex mode (e.g., a 100Base-TX mode). The clock frequency deviation information DEV may be provided by a frequency offset estimation module 116, perhaps by using mechanisms similar to or identical to those outlined in the following references, and known to those of skill in the art: “Simultaneous Clock Phase and Frequency Offset Estimation,” Scott, K. E. and Olasz, E. B., in IEEE Transactions on Communications, Vol. 43, Issue: 7, July 1995, pgs. 2263-2270; “Compensating Frequency Drift in DPSK Systems via Baseband Signal Processing,” Zae Yong Choi and Yong Hoon Lee in IEEE Transactions on Communications, Vol. 45, Issue: 8, August 1997, pg. 921-924; and “DSP-Based Clock Recovery Implemented in a Field Programmable Gate Array,” Smithson, P. M., Tomlinson, M., and Donnelly, T., in IEEE Colloquium on New Synchronisation Techniques for Radio Systems, 27 Nov. 1995, Pgs. 8/1-8/6.

In some embodiments, the time recovery module 122 may include a phase recovery module 126 to couple to a clock generator control module 130 having an output 134 adjusted according to a selection of the clock frequency deviation information DEV, wherein the selection may be provided by the operational mode indication OMI. Thus, the time recovery module 122 may also include a selection module 138 to receive the operational mode indication OMI to select one of: the clock frequency deviation information DEV and no deviation. If operation in the slave mode is indicated by the operational mode indication OMI, then the external frequency input 142 may be selected. This may occur, for example, if the time recovery module 122 is included in another channel (e.g., channel B), and the selected channel (e.g., channel A) is providing clock frequency deviation information DEV to the other channel.

The time recovery module 122 may include a clock generator control module 130 to couple to the selection module 138 and an output 146 of the phase recovery module 126. One or more control signal outputs 134 may be provided to a clock generation module 150 by the clock generator control module 130.

As noted above, the operational mode indication OMI may be selected from one of: a slave mode indication, a master mode indication, a full duplex indication, a half-duplex indication, a 1000Base-T indication, and a 100Base-TX indication, among others. The operational mode indication OMI may be coupled to the selected channel 114, as well as to one or more of the remainder of the plurality of receiver channels 114″.

In some embodiments, the plurality of receiver channels 114 may be included in a physical layer (PHY) transceiver 154. The plurality of receiver channels 114 may also be included in a communications link controller 158. The PHY transceiver 154 and the communications link controller 158 may operate according to an IEEE 802.3 standard.

Other embodiments may be realized. For example, turning now to FIG. 1B, it can be seen that a system 110, such as an Ethernet controller attached to a motherboard, or to a computer bus expansion board, may include one or more apparatus 100 as described above, as well as a processor 154 to derive information INF from the data signal D-SIG, and a display 158 to display the information INF.

In some embodiments, the system 110 may include a computer motherboard 162 to supply operational power to the plurality of receiver channels 114. The system 110 may also include an expansion board 166 coupled to a computer motherboard 162, wherein the expansion board 166 is to supply operational power to the plurality of receiver channels 114.

The system 110 may also include an antenna 170 to transmit the information INF to a wireless network 174. While many embodiments of the apparatus 100 and systems 110 involve a point-to-point connection (e.g., a four channel, twisted pair connection between the transmitter 118, including a master mode transmitter, and the receiving system 110, including a slave mode receiver), other embodiments are possible. Thus, the information INF may also be routed to various clients CL1, CL2, and CL3, perhaps operating as slave receivers, with the apparatus 100 and systems 110 operating as a master transmitter. In this case, some information INF may be transmitted using a 1000Base-T network (e.g., to clients CL1 and CL2, using a four channel, twisted pair connection in each case), and some of the information INF may be transmitted using a 100Base-TX network (e.g., to client CL3, using a two channel, twisted pair connection). A variety of roles may be assumed, with the apparatus 100 and systems 110 operating as a master transmitter or receiver, or as a slave transmitter or receiver.

Any of the components previously described can be implemented in a number of ways, including simulation via software. Thus, the apparatus 100; systems 110; channels 114, 114′, 114″, A, B; frequency offset estimation module 116; transmitter 118; time recovery module 122; phase recovery module 126; clock generator control module 130; outputs 134, 146; selection module 138; external frequency input 142; clock generation module 150; PHY transceiver 154; link controller 158; motherboard 162; expansion board 166; antenna 170; wireless network 174; clients CL1, CL2, CL3; clock frequency deviation information DEV; data signal D-SIG; and operational mode indication OMI may all be characterized as “modules” herein.

Such modules may include hardware circuitry, single and/or multi-processor circuits, memory circuits, software program modules and objects, and/or firmware, and combinations thereof, as desired by the architect of the apparatus 100 and systems 110, and as appropriate for particular implementations of various embodiments. For example, such modules may be included in a system operation simulation package, such as a software electrical signal simulation package, a power usage and distribution simulation package, a capacitance-inductance simulation package, a power/heat dissipation simulation package, a signal transmission-reception simulation package, and/or a combination of software and hardware used to operate, or simulate the operation of various potential embodiments.

It should also be understood that the apparatus and systems of various embodiments can be used in applications other than Ethernet controllers, PHY transceivers, and expansion boards, and thus, various embodiments are not to be so limited. The illustrations of apparatus 100 and systems 110 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single and/or multi-processor modules, single and/or multiple embedded processors, data switches, and application-specific modules, including multilayer, multi-chip modules. Such apparatus and systems may further be included as sub-components within a variety of electronic systems, such as televisions, cellular telephones, personal computers, switches, hubs, routers, workstations, radios, video players, vehicles, and others.

Some embodiments may also be realized by modifying off-the-shelf products to incorporate the apparatus 100 described herein. Such products may include, for example, an Intel Ethernet link controller (Part Nos. 82571EB and 82541PI), a Broadcom 10/100/1000BASE-T Controller with Integrated Transceiver (Part No. BCM5705M), a Vitesse Single Port 10/100/1000BASE-T PHY (Part No. VSC8201), and a Marvell PCI Express Gigabit Ethernet Controller (Part No. 88E8050).

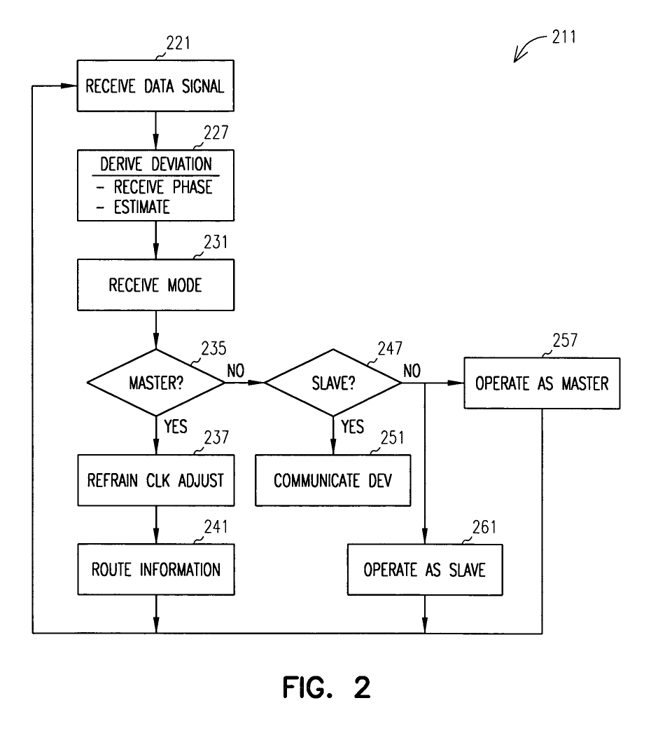

Some embodiments may include a number of methods. For example, FIG. 2 is a flow diagram illustrating several methods 211 according to various embodiments of the invention. A method 211 may include receiving a data signal from a transmitter, such as a server, at a selected channel included in a plurality of receiver channels at block 221, and then continue with deriving clock frequency deviation information from the data signal at block 227. Deriving the clock frequency deviation information at block 227 may include receiving phase recovery information from the data signal, as well as estimating the amount of frequency deviation in the data signal.

The method 211 may include receiving an operational mode indication at block 231, perhaps indicating one of a slave mode, a master mode, a full-duplex mode, or a half-duplex mode. If the operational mode indication indicates a master mode at block 235, for example, the method 211 may include refraining from adjusting the clock generator frequency according to the clock frequency deviation information at block 237. The method 211 may also include routing information derived from the data signal to a slave mode receiver at block 241.

In some embodiments, if the received operational mode indication indicates a slave mode at block 247, the method 211 may include communicating the clock frequency deviation information to a remainder of the plurality of receiver channels responsive to receiving the operational mode indication at block 251. Thus, the method 211 may include synchronizing the remainder of the plurality of channels to a clock in the transmitter according to the clock frequency deviation information at block 251.

In some embodiments, if the received operational mode indication indicates a half-duplex mode at block 247, the method 211 may include operating as a master unit while transmitting the data signal at block 257. If the operational mode indication indicates a half-duplex mode at block 247, the method 211 may also include operating as a slave unit while receiving the data signal at block 261. Operation in the master and slave modes may be according to an IEEE 802.3 standard.

It should be noted that the methods described herein do not have to be executed in the order described, or in any particular order. Moreover, various activities described with respect to the methods identified herein can be executed in repetitive, simultaneous, serial, or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java, Smalltalk, or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment, including Hypertext Markup Language (HTML) and Extensible Markup Language (XML). Thus, other embodiments may be realized.

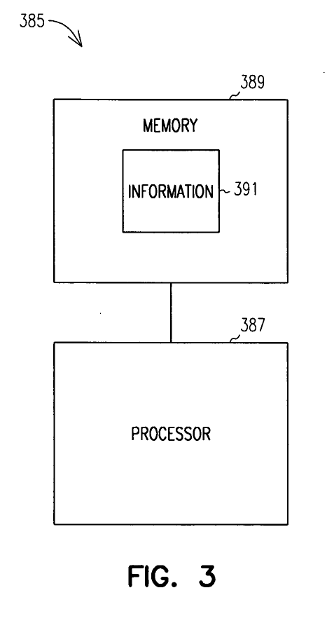

FIG. 3 is a block diagram of an article 385 according to various embodiments, such as a computer, a memory system, a magnetic or optical disk, some other storage device, and/or any type of electronic device or system. The article 385 may include a processor 387 coupled to a machine-accessible medium such as a memory 389 (e.g., a memory including an electrical, optical, or electromagnetic conductor) having associated information 391 (e.g., a computer program instructions and/or data), which, when accessed, results in a machine (e.g., the processor 387), performing such actions as receiving a data signal from a transmitter at a selected channel included in a plurality of receiver channels, deriving clock frequency deviation information from the data signal, receiving an operational mode indication indicating a slave mode, and communicating the clock frequency deviation information to a remainder of the plurality of receiver channels responsive to receiving the operational mode indication.

Further activities may include receiving the operational mode indication indicating one of the slave mode, a master mode, and a half-duplex mode, as well as routing information derived from the data signal to a slave mode receiver. Additional activities may include receiving an operational mode indication indicating a half-duplex mode; and operating as a slave unit while receiving the data signal, perhaps according to an IEEE 802.3 standard.

Implementing the apparatus, systems, and methods disclosed herein may enable reliable full-duplex communications over greater cable lengths. In some cases, the accuracy requirements for initial estimates of the echo transfer function may be lowered, permitting use of a larger variety of components. Alternatively, initial estimates may be created by simpler, less accurate and possibly less expensive methods. Channel ocking times may be decreased.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, including:
a plurality of receiver channels including a selected channel to receive a data signal from a transmitter; and
a time recovery module to communicate clock frequency deviation information derived from the data signal to a remainder of the plurality of receiver channels responsive to an operational mode indication indicating a slave mode

2. The apparatus of claim 1, wherein the time recovery module further includes:
a phase recovery module to couple to a clock generator control module having an output adjusted according to a selection of the clock frequency deviation information.

3. The apparatus of claim 1, wherein the time recovery module further includes:
a selection module to receive the operational mode indication and to select one of: the clock frequency deviation information and no deviation.

4. The apparatus of claim 3, wherein the time recovery module further includes: a clock generator control module to couple to the selection module and an output of a phase recovery module and to provide control signals to a clock generation module.

5. The apparatus of claim 1, wherein the operational mode indication is selected from one of: a slave mode indication and a master mode indication.

6. The apparatus of claim 1, wherein the operational mode indication is selected from one of: a full duplex indication and a half-duplex indication.

7. The apparatus of claim 1, wherein the operational mode indication is coupled to at least one of the remainder of the plurality of receiver channels.

8. The apparatus of claim 1, wherein the plurality of receiver channels are included in a communications link controller operating according to an Institute of Electrical and Electronics Engineers 802.3 standard.

9. The apparatus of claim 1, wherein the plurality of receiver channels are included in a physical layer transceiver.

10. The apparatus of claim 1, wherein the time recovery module is included in the selected channel, and wherein a duplicate of the time recovery module is included in at least one of the remainder of the plurality of receiver channels.

11. A system, including:
a plurality of receiver channels including a selected channel to receive a data signal from a transmitter;
a time recovery module to communicate clock frequency deviation information derived from the data signal to a remainder of the plurality of receiver channels responsive to an operational mode indication indicating a slave mode;
a processor to derive information from the data signal; and
a display to display the information.

12. The system of claim 11, further including:
a computer motherboard to supply operational power to the plurality of receiver channels.

13. The system of claim 11, further including:
an expansion board coupled to a computer motherboard, wherein the expansion board is to supply operational power to the plurality of receiver channels.

14. The system of claim 11, further including:
an antenna to transmit the information to a wireless network.

15. A method, including:
receiving a data signal from a transmitter at a selected channel included in a plurality of receiver channels;
deriving clock frequency deviation information from the data signal;
receiving an operational mode indication indicating a slave mode; and
communicating the clock frequency deviation information to a remainder of the plurality of receiver channels responsive to receiving the operational mode indication.

16. The method of claim 15, further including:
synchronizing the remainder of the plurality of channels to a clock in the transmitter according to the clock frequency deviation information.

17. The method of claim 15, wherein deriving the clock frequency deviation information includes:
receiving phase recovery information from the data signal.

18. The method of claim 15, wherein deriving the clock frequency deviation information includes:
estimating an amount of frequency deviation in the data signal.

19. The method of claim 15, further including:
receiving the operational mode indication indicating a master mode; and
refraining from adjusting a clock generator frequency according to the clock frequency deviation information.

20. The method of claim 15, further including:
receiving an operational mode indication indicating a half-duplex mode; and
operating as a master unit while transmitting the data signal.

21. An article including a machine-accessible medium having associated information, wherein the information, when accessed, results in a machine performing:
receiving a data signal from a transmitter at a selected channel included in a plurality of receiver channels;
deriving clock frequency deviation information from the data signal;
receiving an operational mode indication indicating a slave mode; and
communicating the clock frequency deviation information to a remainder of the plurality of receiver channels responsive to receiving the operational mode indication.

22. The article of claim 21, wherein the information, when accessed, results in the machine performing:
routing information derived from the data signal to a slave mode receiver.

23. The article of claim 21, wherein the information, when accessed, results in the machine performing:
receiving the operational mode indication indicating one of the slave mode, a master mode, and a half-duplex mode.

24. The article of claim 21, wherein the information, when accessed, results in the machine performing:
receiving an operational mode indication indicating a half-duplex mode; and
operating as a slave unit while receiving the data signal.

25. The article of claim 21, wherein the information, when accessed, results in the machine performing:
operating in the slave mode according to an Institute of Electrical and Electronic Engineers 802.3 standard.
